(19) United States
(12) Patent Application Publication
(10) Pub. No.: US 2006/0198161 A1
(43) Pub. Date: Sep. 7, 2006

(54) DIRECT TYPE BACKLIGHT MODULE

(76) Inventor: Jhy-Chain Lin, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/162,362

(22) Filed: Sep. 8, 2005

(30) Foreign Application Priority Data
Mar. 5, 2005 (CN) 200510033482.1

(51) Int. Cl. F21V 7/04

(52) U.S. Cl. 362/613

(57) ABSTRACT

A direct type backlight module (100) includes a substrate (110) and a number of light sources (120) and a plurality of thermal electric coolers (160). The substrate has a first surface (111) and a second surface (112), and the light sources are formed on the first surface of the substrate, the TE coolers are arranged on the second surface of the substrate. Each TE cooler has a cold portion (161) and a hot portion (162), the cold portion contacts with the second surface of the substrate. The hot portion connects with at least one heat pipe (170). The heat pipe includes a evaporation portion and a condensation portion, the evaporation portion contacts with the hot portion. The condensation portion contacts with a heat sink (180). A fan (190) is arranged at one side of the heat sink, and an opposite side of the heat sink defines a plurality of vents (195). The direct type backlight module has improved heat dissipation performance.

### FIELD OF THE INVENTION

The present invention relates to a backlight module, especially to a direct type backlight module.

### DESCRIPTION OF RELATED ART

Most LCD devices are passive devices in which images are displayed by controlling an amount of light input from an outside light source. Thus, a separate light source (for example, backlight module) is generally employed for irradiating an LCD.

Generally, backlight module can be classified into edge type and direct type, based upon arrangement of lamps within the device. An edge type backlight module has a lamp unit arranged at a side portion of a light guiding plate for guiding light. Edge type backlight modules are commonly employed in small-sized LCD due to their lightweight, miniature and low electric consumption. However, the edge type backlight modules are not suitable for large-sized LCD (20 inches or more). A direct type backlight module has a plurality of lamps arranged in regular positions to directly irradiate an entire surface of an LCD panel. The direct type backlight modules have higher efficiency of light usage and longer operational lifetime than the edge type backlight modules, and are specially provided for large-sized LCD devices. However, an LCD device usually employs tens of lamps to reach a high luminance. These lamps produce a great deal of heat cumulated inside the LCD device. Therefore, heat dissipation of the direct type backlight modules is usually a hard nut to crack.

Referring to FIG. 4, a conventional direct type backlight module 50 includes a reflective plate 58 connected to a diffuser panel 16, and a first cavity 60 is defined therebetween. The reflective plate 58 has a bottom portion 581 and a side portion 582. A few first convective openings 621 are defined in the bottom portion 581 of the reflective plate 58. A few lamps 14 are arranged in the first cavity 60, each of which corresponds to one of the first convective opening 621. The backlight module 50 further includes a heat dissipation panel 59 connected to the reflective plate 58. A second cavity 70 is formed between the heat dissipation panel 59 and the reflective plate 58. The first cavity 60 is in communication with the second cavity 70 via the first convective openings 621. A few second convective openings 64 are defined in the side portion 582 of the reflective plate 58 in communication with the first cavity 60 and the second cavity 70. The heat dissipation panel 59 contacts with a frame 54 that has finlike structure 541 for heat dissipation. Heat produced by the lamps 14 can be converted to the heat dissipation panel 59 via the first convective opening 621 and the second convective opening 64 and dispersed in air outside the backlight module 50. Thus, a temperature of the backlight module 50 can be maintained at a normal level to prolong the lifetime of it.

However, the dissipation rate is slow and limited, because the heat produced by the lamps 14 can only be dispersed by natural convection mode, whose heat conductivity is only 11.3 to 55 W/m²·K. Therefore, when the backlight module 50 keeps on working for a long time, the temperature inside the backlight module 50 rises and the performance of the lamp will be deteriorated.

Therefore, a heretofore-unaddressed need exists in the industry to address the aforementioned deficiencies and inadequacies.

### SUMMARY OF INVENTION

In a preferred embodiment, a direct type backlight module is provided, which comprises a substrate and a number of light sources. The substrate has a first surface and a second surface, and the light sources are formed on the first surface of the substrate, on the second surface of the substrate there are several thermal electric (TE) coolers.

Each TE cooler has a cold portion and a hot portion, the cold portion contacts with the second surface of the substrate. The hot portion of the TE cooler connects with at least one heat pipe.

Each heat pipe comprises an evaporation portion and a condensation portion, the evaporation portion contacts with the hot portion of the TE cooler. The condensation portions connect with a heat sink.

A fan is arranged at one side of the heat sink, and the other side opposite to the fan defines a vent.

Comparing with the conventional backlight module, the direct type backlight module of the preferred embodiment has the following advantages. Firstly, the light sources can work at a normal working temperature, thus a performance of the light sources can be kept stable. Secondly, when the temperature is higher than the normal working temperature, heat can be removed from the light sources by the electricity effect of TE cooler, and then be conveyed from the cold portion to the hot portion. Thirdly, the heat pipe can absorb heat and convey the heat from the evaporation portion to the condensation portion, and then conduct to heat sink. Finally, the design of the fan and vent can speed heat outside under physical effect. Therefore, the direct type backlight module of the preferred embodiment has an improved heat dissipation performance.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cutaway schematic view of a preferred embodiment of the present invention;

FIG. 2 is a planform of the direct type backlight module shown in FIG. 1, with a dual brightness enhancement film and a diffuser panel removed;

FIG. 3 is a cutaway schematic view of a heat pipe of the preferred embodiment of the present invention; and

FIG. 4 is a cutaway schematic view of a conventional backlight module.

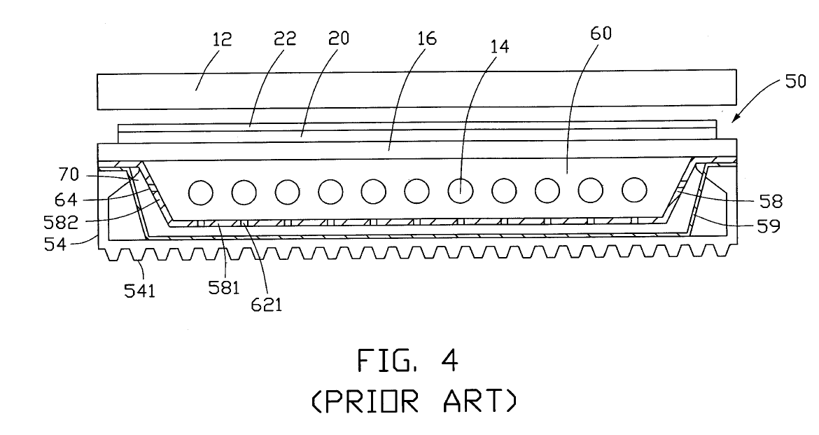

### DETAILED DESCRIPTION

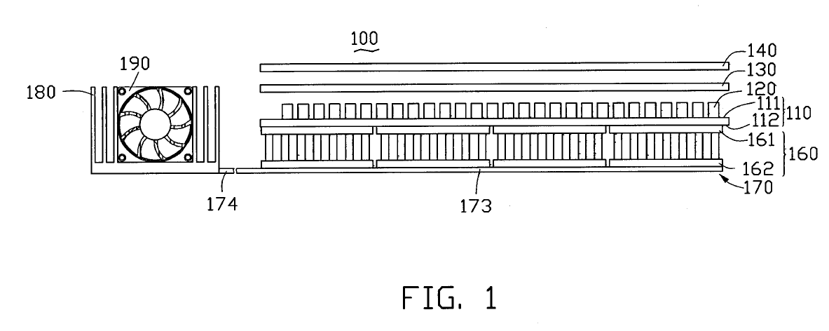

Referring to FIG. 1, a direct type backlight module 100 according to the preferred embodiment of the present invention includes a substrate 110, a number of light sources 120, a dual brightness enhancement film (DBEF) 130 and a diffuser panel 140. The substrate 110 has a first surface 111 and a second surface 112. The substrate 110 can be made of copper, iron or related alloy. The light sources 120 can be cold cathode fluorescent lamps (CCFLs), light-emitting diodes (LEDs) or LED beams. In the preferred embodiment they are LEDs. The light sources 120 are regularly arranged on the first surface 111 of the substrate 110. The DBEF 130 is disposed over the light sources 120, for enhancing brightness by improving a utility efficiency of light to get a higher luminance for the backlight module 100. The diffuser panel 140 is arranged over the DBEF 130 to get a uniform output light.

A number of thermal electric coolers 160 are arranged on the second surface 112 of the substrate 110, i.e., a surface opposite to the light sources 120. Each TE cooler 160 includes a cold portion 161 and a hot portion 162. The cold portion 161 contacts with the second surface 112 of the substrate 110, and the hot portion 162 contacts with at least one heat pipe 170.

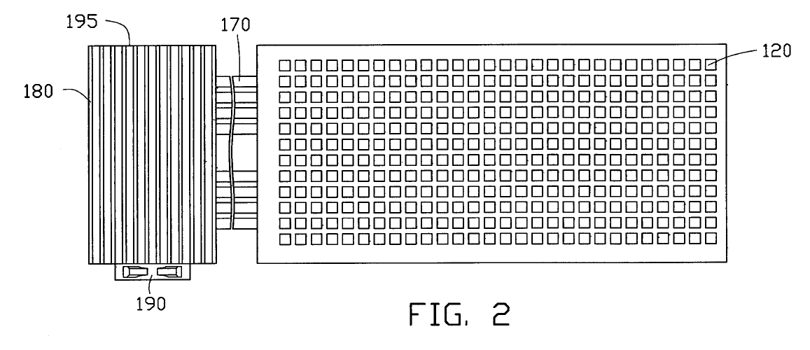

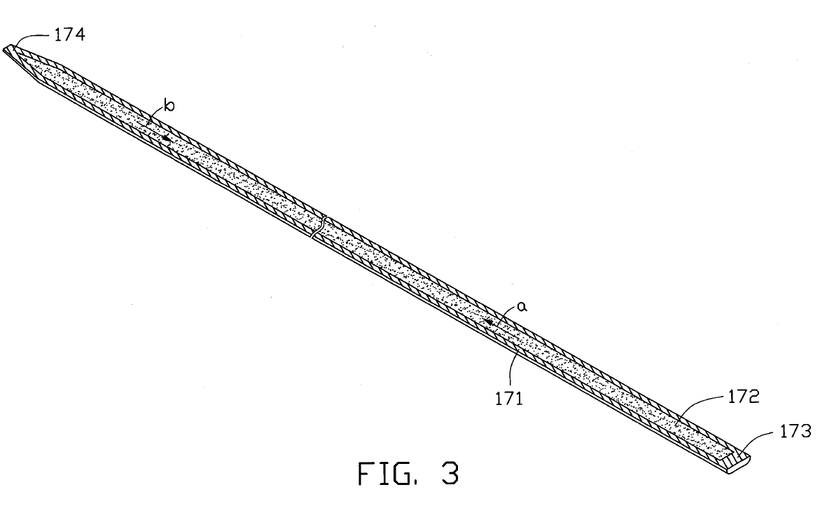

Referring to FIGS. 2 and 3, the heat pipe 170 can be flat, cylindrical or conical. The heat pipe 170 has two portions: an evaporation portion 173 and a condensation portion 174. The evaporation portion 173 closely contacts with the hot portion 162 of the TE cooler 160, and the condensation portion 174 contacts with a heat sink 180. A fan 190 is disposed on one side of the heat sink 180.

Referring to FIG. 2, the heat pipes 170 connect the TE cooler 160 (see FIG. 1) and the heat sink 180 for conveying heat from the TE cooler 160 to the heat sink 180. The light sources 120 are disposed on the substrate 110 in a regular array. Each heat pipe 170 corresponds to a number of light sources 120 for conveying heat produced by the light sources 120 to the heat sink 180. The fan 190 is arranged at one side of the heat sink 180, and an opposite side of the heat sink 180 defines a plurality of vents 195.

Referring to FIG. 3, the heat pipe 170 comprises a hermetic container 171, a capillary structure 172 and a working liquid having a certain boiling point. The hermetic container 171 is airproofed and encloses the capillary structure 172. The working liquid is saturated in the capillary structure 172. When the evaporation portion 173 of the heat pipe 170 is heated, the working liquid boils to vapor. Heat absorbed in the evaporation portionl73 is thus conveyed to and stockpiled in the vapor. The vapor is driven by a gas pressure difference and flows to the condensation portion 174, which has a relatively lower temperature. The vapor is condensed into liquid and releases heat. Thereby, the heat pipe 170 conveys heat from evaporation portion 173 to the condensation portion 174. Under the capillarity of the capillary structure 172 or gravitation, the condensed working fluid flows back to the evaporation portion 173 for next cycle. An arrowhead labeled as “a” in FIG. 3 represents the direction of the vapor flows, and other arrowhead that labeled as “b” represents the direction of the condensate liquid flows.

A mechanism of the preferred embodiment of the direct type backlight module 100 will be described below. When the light sources 120 are in operation, the light sources 120 produce heats. When the heats cumulate to a certain degree, it is conducted to the substrate 110 rapidly and uniformly. Then the heat is absorbed by the cold portion 161 of the TE cooler 160, and is conveyed to the hot portion 162. The heat cumulated at the hot portion 162 of the TE cooler 160 is absorbed by the heat pipe 170 and is conveyed from the evaporation portion 173 to the condensation portion 174, and then is conveyed to the heat sink 180 connected with the condensation portion 174. Finally, the heat is dispersed in air by the heat sink 180. Thus, the temperature of the cold portion 161 of the TE coolers 160 can be maintained at a normal level. Therefore, the light sources 120 can work at a normal temperature. Thereby, the light sources 120 can be prevented from being burnout due to cumulated heat, and performance of the light sources can be kept stable.

Comparing with a conventional backlight module, the direct type backlight module of the preferred embodiment has the following advantages. Firstly, the light sources can work at a normal temperature, thus a performance of the light sources can be kept stable. Secondly, when the temperature is higher than the normal temperature, heat can be removed from the light sources by the electricity effect of TE cooler, and then is conveyed from the cold portion to the hot portion. Thirdly, the heat pipe can absorb heat and convey the heat from the evaporation portion to the condensation portion, and then conduct to heat sink. Finally, the design of the fan and vent can blow heat outside under physical effect. Therefore, the direct type backlight module of the preferred embodiment has an improved heat dissipation performance.

What is claimed is:

1. A direct type backlight module comprising:
a substrate having a first surface and a second surface;
a number of light sources formed on the first surface of the substrate; and
a plurality of thermal electric coolers arranged on the second surface of the substrate.

2. The direct type backlight module as claimed in claim 1, wherein each thermal electric cooler has a cold portion and a hot portion, the cold portion contacting with the second surface of the substrate.

3. The direct type backlight module as claimed in claim 2, wherein the hot portion of the thermal electric cooler connects with at least one heat pipe.

4. The direct type backlight module as claimed in claim 3, wherein the heat pipe is flat.

5. The direct type backlight module as claimed in claim 3, wherein the heat pipe is cylindrical.

6. The direct type backlight module as claimed in claim 3, wherein the heat pipe is conical.

7. The direct type backlight module as claimed in claim 3, wherein the heat pipe comprises a hermetic container enclosing a capillary structure and a working liquid having a predetermined boiling point, the hermetic container being airproofed, the working liquid being saturated in the capillary structure.

8. The direct type backlight module as claimed in claim 3, wherein the heat pipe comprises an evaporation portion and a condensation portion, the evaporation portion contacts with the hot portion of the thermal electric cooler.

9. The direct type backlight module as claimed in claim 8, wherein the condensation portion connects with a heat sink.

10. The direct type backlight module as claimed in claim 9, wherein a fan is disposed on one side of the heat sink, and an opposite side of the heat sink defines a plurality of vents.

11. The direct type backlight module as claimed in claim 1, wherein the light sources are cold cathode fluorescent lamps.

12. The direct type backlight module as claimed in claim 1, wherein the light sources are light-emitting diodes.

13. The direct type backlight module as claimed in claim 1, wherein the light sources are light-emitting diode beams.

14. The direct type backlight module as claimed in claim 1, wherein the substrate is made of copper, iron or its alloy.

15. The direct type backlight module as claimed in claim 1, further comprising a dual brightness enhancement film over the light sources for enhancing brightness.

16. The direct type backlight module as claimed in claim 11, further comprising a diffuser panel above the dual brightness enhancement film.
